(19) United States
(12) Patent Application Publication
(10) Pub. No.: US 2014/0086117 A1
(43) Pub. Date: Mar. 27, 2014

(54) Control Signalling in Carrier Aggregation System

(71) Applicant: Nokia Siemens Networks Oy, Espoo (FI)

(72) Inventors: Li Zhang, Beijing (CN); Peter Skov, Beijing (CN); Chunli Wu, Beijing (CN); Jie Zhen Lin, Beijing (CN)

(73) Assignee: Nokia Siemens Networks Qy, Espoo (FI)

(21) Appl. No.: 14/115,119

(22) PCT Filed: May 3, 2011
(86) PCT No.: PCT/CN2011/073605

§ 371 Date: Nov. 1, 2013

(51) Int. Cl. H04J 3/16

(52) U.S. Cl. CPC H04J 3/1694
USPC 370/280

(57) ABSTRACT

There is provided a timing entity for a communication network which includes a base station and a user equipment capable of communicating with each other over at least two carriers which have different temporal configuration of its uplink and downlink resources. The timing entity includes a control entity adapted for determining timing data defining a timing of a control signalling transmission which is related to a data transmission on a first carrier and which uses a resource of a first type on the second carrier. According to an embodiment the timing data specify for the control signalling transmission a time slot in which there is available a resource of the first type on the second carrier for the control signalling transmission. The control entity may be implemented in a base station and/or a user equipment.

### FIELD OF INVENTION

The present invention relates to the field of communication networks, e.g. cellular communication networks.

### BACKGROUND OF THE INVENTION

In current cellular communication networks a user equipment (e.g. a terminal) can receive and transmit via only one carrier which has a certain bandwidth. In order to increase the available bandwidth it has been considered to aggregate two or more carriers as is described e.g. in 3GPP LTE Advanced (LTE Release 10). Herein, 3GPP refers to the “3rd generation partnership project” and LTE refers to “3GPP long term evolution”.

As is described in 3GPP TS 36.211 V9.1.0 (March 2010), individual carriers may have different time division duplex (TDD) configuration allowing to configure a specific TDD configuration for each carrier. This is referred to as carrier-specific TDD configuration.

When TDD carriers with different configurations are aggregated for a single TDD user equipment, one option is to forbid simultaneous transmission and reception, that means certain subframes cannot be scheduled. Then another option is to allow simultaneous transmission and reception, then all subframes can be scheduled, but the timing of control signaling transmission is a problem. In view of the above-described situation, there exists a need for an improved technique that enables to provide for carrier aggregation in communication networks while substantially avoiding or at least reducing one or more of the above-identified problems.

### SUMMARY OF THE INVENTION

This need may be met by the subject matter according to the independent claims. Advantageous embodiments of the herein disclosed subject matter are described by the dependent claims. According to a first aspect of the invention there is provided a timing entity of a communication network including a base station and a user equipment capable of communicating with each other over at least two carriers, the at least two carriers including a first carrier and a second carrier, both having uplink and downlink resources, the first carrier and the second carrier having different temporal configuration of its uplink and downlink resources, wherein the timing entity comprises a control entity adapted for determining timing data defining a timing of a control signaling transmission being related to a data transmission on the first carrier; the control signaling transmission using a resource of a first type on the second carrier, wherein the resource of the first type is either an uplink resource or a downlink resource; and the timing data specifying for the control signaling transmission a time slot in which there is available a resource of the first type on the second carrier for the control signaling transmission.

This aspect of the herein disclosed subject matter is based on the idea that control signaling timing problems can be avoided by providing a timing entity which specifies a time slot with a first resource, used by the control signaling transmission, on the second carrier.

According to an embodiment, the determination of time slot for the control signaling transmission is based on the temporal configuration of the uplink and downlink resources of both, the first carrier and the second carrier.

Usually, the temporal configuration of uplink and downlink resources of a carrier is hard coded, i.e. the temporal configuration is not changed during operation. For a single carrier transmission, also timing of control signaling transmissions need not be changed during operation.

However, the timing entity according to embodiments of the herein disclosed subject matter allows for a change of a timing of control signaling transmissions, even while still using hard coded carrier specific TDD configurations for the carriers that may be aggregated for increasing the bandwidth.

According to an embodiment, the first carrier and the second carrier are spaced by a certain frequency interval of non-zero width (non-continuous carrier aggregation).

According to an embodiment, the communication network is wireless communication network. According to a further embodiment, the communication network is a cellular communication network. For example, in a further embodiment, the cellular communication network is based on LTE advanced technology described in 3GPP LTE Release 10.

According to an embodiment, control entity is used for determining the timing of two or more control signaling transmissions. According to an embodiment, these timings are then stored for a later use. For example, in an embodiment, all possible configurations and combinations of configurations of two aggregateable carriers may be analyzed and the respective timing data may be determined by the timing entity. Further, the timing entity, or another entity, may store such timing data for a later use.

According to a further embodiment, the data transmission occurs in a first time slot n; and the timing data specify for the control signaling transmission a second time slot tg; wherein the second time slot tg is spaced by a temporal distance from the first time slot n; the temporal distance is greater than or equal to a maximum time duration required for signaling between the base station and the user equipment while the second time slot is the temporally closest time slot providing a resource of the first type required for the control signaling transmission.

Various configurations requiring different time slot configurations are possible. For example, the timing data determination for a single control signal transmission or for several control signal transmissions are taken into account.

In this regard it should be understood that referral to a second Lime slot only serves to differentiate the respective time slot from a first time slot. The numbering however has no further meaning. For example if two of the control signal transmissions are considered, the respective time slots may be labeled as second time slot, third timeslot, etc.

According to a further embodiment, the data transmission is an uplink data transmission on the first carrier occurring in a first time slot n; the control signaling transmission is an uplink grant signaling transmission; and the timing data specify for the uplink grant signaling transmission a second time slot tg=n−k1, wherein k1 is the smallest number of time slots which (i) spaces the second time slot tg from the first time slot n by a time duration greater than or equal to a maximum time duration required for signaling between the base station and the user equipment and (ii) ensures the second time slot provides a downlink resource on the second carrier.

According to a further embodiment, the data transmission, e.g. an uplink data transmission occurs in a first time slot n; and the control signaling transmission is an acknowledgement/non-acknowledgement signaling transmission; the timing data further specifying for the acknowledgement/non-acknowledgement signaling transmission a second time slot ta=n+k2, wherein k2 is the smallest number of time slots which (i) spaces the second time slot ta from the first time slot n by a time duration greater than or equal to a maximum time duration required for signaling between the base station and the user equipment and (ii) ensures the second time slot providing a downlink resource on the second carrier.

According to an embodiment, the first carrier corresponds to a scheduled cell, and the second carrier corresponds to a scheduling cell. The maximum time duration required for signaling between the base station and the user equipment used to define k1 and k2 in the above mentioned embodiments, is 9 (in words: “four”) subframes in 3GPP LTE.

In cross-carrier scheduling, i.e. where control signaling transmissions are transmitted over carriers different from the carriers of the data transmission, both a primary cell and a secondary cell can be the scheduling cell.

According to exemplary embodiments, in the embodiment where the control signaling transmission is an uplink grant signaling transmission and the embodiment where the control signaling transmission is an acknowledgement/non-acknowledgement signaling transmission, the first carrier forms a scheduled cell and the second carrier forms a scheduling cell. Having regard to e.g. LTE terminology, these embodiments relate to a PDCCH-PUSCH-PHICH Liming. Herein PDCCH is referred to as physical downlink control channel, PUSCH is referred to as physical uplink shared channel and PHICH is referred to as physical indicator channel as commonly used in 3GPP LTE. In a typical conflict time slot (subframe in 3GPP LTE), the scheduling cell has an uplink resource in the conflict time slot, whereas the scheduled cell has a downlink resource in the scheduled cell. For such a conflict time slot, the timing defined above may be applied. In another typical conflict time slot, the scheduling cell has an downlink resource in the conflict time slot, whereas the scheduled cell has an uplink resource in the scheduled cell. For such a conflict time slot, as well as for non-cross carrier scheduling, a release 8 or release 9 or release 10 timing may be also applied.

According to a further embodiment, the data transmission is an downlink data transmission on the first carrier occurring in a first time slot n; and the control signaling transmission is a downlink assignment signaling transmission; the timing data specifying for the downlink assignment signaling transmission a second time slot tg which is the latest time slot before the first time slot n that provides a downlink resource on the second carrier.

According to exemplary embodiments, in the embodiment where the control signaling transmission is a downlink assignment signaling transmission, the first carrier forms a scheduled cell and the second carrier forms a scheduling cell. Having regard to e.g. LTE terminology, these embodiments relate to a PDCCH-PDSCH timing. Herein PDCCH is referred to as physical downlink control channel, PDSCH is referred to as physical downlink shared channel as commonly used in 3GPP LTE. In a typical conflict time slot (subframe in 3GPP LTE), the scheduling cell has an uplink resource in the conflict time slot, whereas the scheduled cell has a downlink resource in the scheduled cell. For such a conflict time slot, the timing defined above may be applied. In another typical conflict time slot, the scheduling cell has an downlink resource in the conflict time slot, whereas the scheduled cell has an uplink resource in the scheduled cell. For such a conflict time slot, as well as for non-cross carrier scheduling, a release 8, or release 9, or release 10 timing as described for LTE may be also applied.

According to an embodiment, the data transmission is a downlink data transmission on the first carrier occurring in a first time slot n; and the control signaling transmission is an acknowledgement/non-acknowledgement signaling transmission; the timing data specifying for the acknowledgement/non-acknowledgement signaling transmission a second time slot ta=n+k2, wherein k2 is the smallest number of time slots which (i) spaces the second time slot ta from the first time slot n by a time duration greater than or equal to a maximum time duration required for signaling between the base station and the user equipment and which (ii) ensures the second time slot providing an uplink resource on the second carrier.

According to exemplary embodiments, in the embodiment where the control signaling transmission is an acknowledgement/non-acknowledgement signaling transmission, the first carrier forms a secondary cell and the second carrier forms a primary cell. As is common terminology, herein a primary cell is the cell in which the UE performs initial connection/reconnection whereas a secondary cell may only be configured if a connection/reconnection of the UE to a primary cell is already established. Having regard to e.g. LTE terminology, these embodiments relate to a PDSCH-Ack/Nack timing. Herein PDSCH is referred to as physical downlink shared channel, whereas Ack/Nack is referred to as acknowledge/non-acknowledge. In a typical conflict time slot (subframe in 3GPP LTE), the secondary cell has an uplink resource in the conflict time slot, whereas the primary cell has a downlink resource. For such a conflict time slot, the timing defined above may be applied. In another typical conflict time slot, the primary cell has a uplink resource in the conflict time slot, whereas the secondary cell has an downlink resource in the scheduled cell. For such a conflict time slot, a release 8 timing, or release 9 timing, or release 10 timing as described for LTE may be also applied.

According to a second aspect of the herein disclosed subject matter, a base station of a communication network is provided, the base station comprising a timing entity according to the first aspect or an embodiment thereof.

According to an embodiment, the control entity of the timing entity is configured for determining the timing data based on configuration indicating data being indicative of the temporal configuration of the uplink and downlink resources on both, the first carrier and the second carrier. Hence, the configuration indicating data is indicative of the temporal configuration of the uplink and the downlink resources of the first carrier and the temporal configuration of the uplink and the downlink resources of the second carrier.

According to an embodiment, the base station comprises a controller. According to a further embodiment, the controller is adapted for transmitting and receiving the control signaling transmission according to the timing data.

According to a further embodiment, the base station further comprises a second controller for providing the timing data to the user equipment. Herein, such an embodiment is also referred to as explicit signaling scheme since it explicitly provides to the user equipment the timing data defining a timing of a control signaling transmission. An advantage may be that the user equipment may not necessarily need a timing entity itself.

According to another embodiment, the controller is adapted for providing the configuration indicating data to the user equipment. As the timing data are not explicitly provided to the user equipment, this embodiment is also referred to herein as implicit signalling scheme. The implicit signalling scheme allows the user equipment to determine the timing data defining a timing of a control signaling transmission by itself, e.g. by means of a timing entity as described herein.

As mentioned above, embodiments of the herein disclosed subject matter relate to an explicit signalling scheme whereas other embodiments relate to an implicit signalling scheme. Hence, in an approach to unify the wording of both schemes, the timing data as well as the configuration indicating data may be referred to as timing related data since both terms are related to the timing of the respective control signalling transmission. However, it should be understood that the timing related data in the form of configuration indicating data do not include data that explicitly specify a timing.

According to an embodiment, the base station is a base station of a cellular communication network, e.g. an e-NodeB capable of operating according to 3GPP LTE Release 10. According to a further embodiment, the term “base station” as used herein includes at least one of (i) a network node providing a radio resource of an air interface, (ii) a control entity for controlling the air interface and (iii) an entity providing access to a core network.

According to further embodiments of the second aspect, the base station is adapted for providing the functionality of one or more of the aforementioned aspects and embodiments and/or for providing the functionality as required by one or more of the aforementioned aspects and embodiments.

According to a third aspect of the herein disclosed subject matter, there is provided a user equipment for a communication network, the user equipment comprising a timing entity according to the first aspect or an embodiment thereof. Such an embodiment of a user equipment may be used with the implicit signalling scheme as it allows determination of timing data from received configuration indicating data. However, the user equipment according to the third aspect may be additionally configured to be operable according to the explicit signalling scheme.

According to an embodiment of the third aspect, the control entity of the timing entity is configured for determining the timing data based on configuration indicating data being indicative of the temporal configuration of the uplink and downlink resources on both, the first carrier and the second carrier. According to a further embodiment, the user equipment further comprises a controller for transmitting and receiving the control signaling transmission according to the timing data.

In case of implicit signaling, the user equipment comprises a controller for receiving configuration indicating data from the base station.

According to further embodiments of the third aspect, the user equipment is adapted for providing the functionality as disclosed with regard to one or more of the aforementioned aspects and embodiments and/or for providing the functionality as required by one or more of the aforementioned aspects and embodiments.

According to a fourth aspect of the herein disclosed subject matter, a user equipment of a communication network is provided, the communication network further including a base station, the user equipment and the base station being capable of communicating with each other over at least two carriers, the at least two carriers including a first carrier and a second carrier, both having uplink and downlink resources, the first carrier and the second carrier having different temporal configuration of its uplink and downlink resources, the user equipment comprising: a controller being adapted for receiving timing data from the base station, the timing data defining a timing of a control signalling transmission being related to a data transmission on the first carrier; the controller being adapted for adjusting, depending on the timing data, the timing of the control signaling transmission by specifying a time slot in which there is available a resource of a first type on the second carrier for the control signaling transmission; and

the resource of the first type being either an uplink resource or a downlink resource.

This aspect relates to the explicit signaling scheme described above with regard to the second aspect. Hence a user equipment according to the fourth aspect is capable of operating with a base station employing the explicit signalling scheme.

According to further embodiments of the fourth aspect, the user equipment is adapted for providing the functionality as disclosed with regard to one or more of the aforementioned aspects and embodiments and/or for providing the functionality as required by one or more of the aforementioned aspects and embodiments.

According to a fifth aspect of the herein disclosed subject matter, there is provided a method of operating a timing entity of a communication network, the communication network including a base station and a user equipment capable of communicating with each other over at least two carriers, the at least two carriers including a first carrier and a second carrier, both having uplink and downlink resources, the first carrier and the second carrier having different temporal configuration of its uplink and downlink resources, the method comprising: determining timing data defining a timing of a control signaling transmission being related to a data transmission on the first carrier; the control signaling transmission being related to the data transmission on the first carrier using a resource of a first type on the second carrier, wherein the resource of the first type is either an uplink resource or a downlink resource; and the timing data specifying for the control signaling transmission a time slot in which there is available a resource of the first type on the second carrier for a transmission of the control signaling being related to the data transmission on the first carrier.

According to further embodiments of the fifth aspect, the method is adapted for providing the functionality as disclosed with regard to one or more of the aforementioned aspects and embodiments and/or for providing the functionality as required by one or more of the aforementioned aspects and embodiments.

According to a sixth aspect of the herein disclosed subject matter, there is provided a method of operating a base station, the method comprising determining timing data according to the method of the fifth aspect or an embodiment thereof.

According to embodiments of the sixth aspect, the method is adapted for providing the functionality as disclosed with regard to one or more of the aforementioned aspects and embodiments and/or for providing the functionality as required by one or more of the aforementioned aspects and embodiments.

According to a seventh aspect of the herein disclosed subject matter, there is provided a method of operating a user equipment of a communication network, the method comprising:

determining timing data according to the method of the fifth aspect or an embodiment thereof.

According to embodiments of the seventh aspect, the method is adapted for providing the functionality as disclosed with regard to one or more of the aforementioned aspects and embodiments and/or for providing the functionality as required by one or more of the aforementioned aspects and embodiments.

According to a eighth aspect of the herein disclosed subject matter, there is provided a method of operating a controller of a user equipment of a communication network, the communication network further including a base station, the user equipment and the base station being capable of communicating with each other over at least two carriers, the at least two carriers including a first carrier and a second carrier, both having uplink and downlink resources, the first carrier and the second carrier having different temporal configuration of its uplink and downlink resources, the method comprising: receiving timing data from the base station, the timing data defining a timing of a control signalling transmission being related to a data transmission on the first carrier; adjusting, depending on the timing data, the timing of the control signaling transmission by specifying a time slot in which there is available a resource of a first type on the second carrier for the control signaling transmission; and the resource of the first type being either an uplink resource or a downlink resource.

According to embodiments of the eighth aspect, the method is adapted for providing the functionality as disclosed with regard to one or more of the aforementioned aspects and embodiments and/or for providing the functionality as required by one or more of the aforementioned aspects and embodiments.

According to an embodiment, the controller of a base station or a user equipment as disclosed herein comprises a first control unit and a second control unit, wherein the first control unit is adapted for adjusting the timing of a control signalling transmission and the second control unit is adapted for receiving/transmitting of timing data/configuration indicating data.

According to an ninth aspect of the herein disclosed subject matter, there is provided a computer program, the computer program being adapted for, when being executed by a data processor, controlling the method as set forth in any one of the fifth aspect or an embodiment thereof.

According to a tenth aspect of the herein disclosed subject matter, there is provided a computer program, the computer program being adapted for, when being executed by a data processor, controlling the method as set forth in anyone of the sixth aspect or an embodiment thereof.

According to a eleventh aspect of the herein disclosed subject matter, there is provided a computer program, the computer program being adapted for, when being executed by a data processor, controlling the method as set forth in any one of the seventh aspect or an embodiment thereof.

According to a twelfth aspect of the herein disclosed subject matter, there is provided a computer program, the computer program being adapted for, when being executed by a data processor, controlling the method as set forth in any one of the eighth aspect or an embodiment thereof.

As used herein, reference to a computer program is intended to be equivalent to a reference to a program element and/or a computer readable medium containing instructions for controlling a computer system to effect and/or coordinate the performance of the above described method.

The computer program may be implemented as computer readable instruction code by use of any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The computer program may be available from a network, such as the World Wide Web, from which it may be downloaded.

The invention may be realized by means of a computer program respectively software. However, the invention may also be realized by means of one or more specific electronic circuits respectively hardware. Furthermore, the invention may also be realized in a hybrid form, i.e. in a combination of software modules and hardware modules.

In the above there have been described and in the following there will be described exemplary embodiments of the subject matter disclosed herein with reference to a timing entity, a base station, an user equipment, respective methods of operation and computer programs. It has to be pointed out that of course any combination of features relating to different aspects of the herein disclosed subject matter is also possible. In particular, some embodiments have been or will be described with reference to apparatus type embodiments whereas other embodiments have been or will be described with reference to method type embodiments. However, a person skilled in the art will gather from the above and the following description that, unless other notified, in addition to any combination of features belonging to one aspect also any combination between features relating to different aspects or embodiments, for example even between features of the apparatus type embodiments and features of the method type embodiments is considered to be disclosed with this application.

The aspects and embodiments defined above and further aspects and embodiments of the present invention are apparent from the examples to be described hereinafter and are explained with reference to the drawings, but to which the invention is not limited.

### BRIEF DESCRIPTION OF THE DRAWINGS

FIG. 1 shows a communication network in accordance with embodiments of the herein disclosed subject matter.

FIG. 2 shows a communication network in accordance with embodiments of the herein disclosed subject matter.

FIG. 3 illustrates a temporal configuration of two carriers and respective transmissions in accordance with embodiments of the herein disclosed subject matter.

FIG. 4 illustrates a timing of a control signalling transmission in accordance with embodiments of the herein disclosed subject-matter.

FIG. 5 illustrates the timing of a control signalling transmission in accordance with embodiments of the herein disclosed subject-matter.

### DETAILED DESCRIPTION

The illustration in the drawings is schematic. It is noted that in different figures, similar or identical elements are provided with the same reference signs or with reference signs, which are different from the corresponding reference signs only within the first digit.

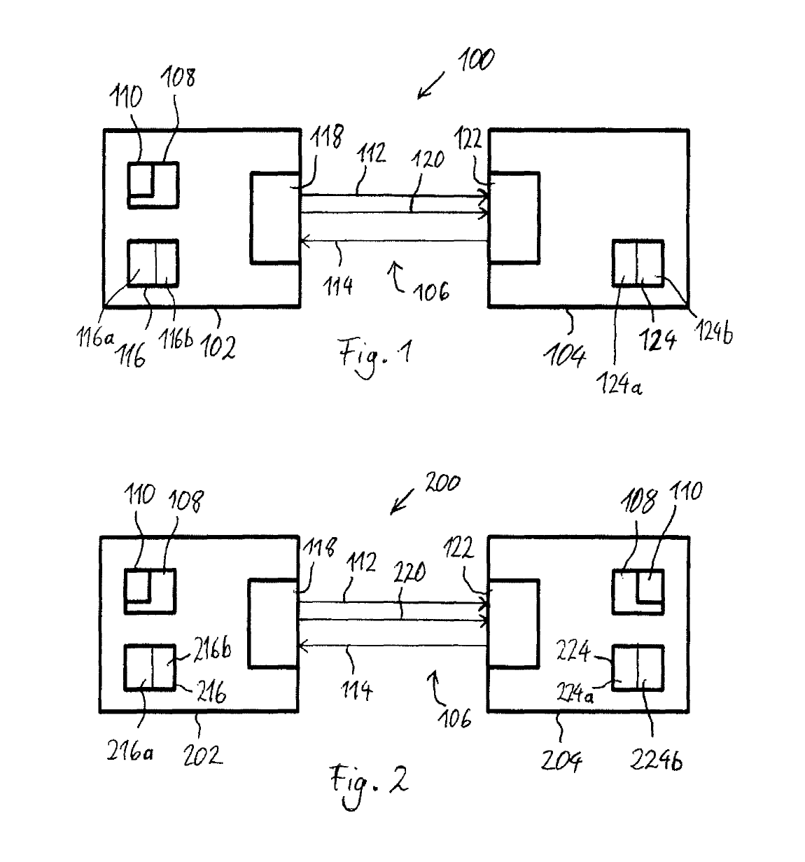

FIG. 1 shows a communication network 100 in accordance with embodiments of the herein disclosed subject matter. The communication network 100 includes a base station 102 and a user equipment 104. The base station 102 and the user equipment 104 are capable of communicating with each other over at least two carriers (not shown in FIG. 1) provided via an air interface 106.

In accordance with an embodiment, the base station 102 comprises a timing entity 108, wherein the timing entity 108 is in accordance with one or more of the embodiments of the herein disclosed subject-matter. According to an embodiment, the timing entity 108 comprises a control entity 110 adapted for determining timing data which define a timing of a control signalling transmission, generally indicated at 112 in FIG. 1. The control signalling transmission 112 is related to a data transmission generally indicated at 114 in FIG. 1. In accordance with an embodiment, the data transmission 114 is performed on a first carrier and the control signalling transmission is performed on a second carrier. Such configurations are used in so-called cross-carrier scheduling.

In accordance with an embodiment, the timing data specify for the control signalling transmission 112 a timeslot in which there is available a resource of a first type on the second carrier for the control signalling transmission 112.

According to an embodiment, the temporal configuration of the uplink and downlink resources of one of the carriers is fixedly coded (also referred to as hard-coded).

However, in case of carrier aggregation, wherein two or more carriers are aggregated to increase the bandwidth available for communication between network entities such as the base station 102 and the user equipment 104, the hard-coded carrier configuration together with a predetermined timing may decrease performance of the system if the carrier aggregation is not properly taken into account in the timing of control signalling transmissions. For example, in LTE (LTE=Third Generation Partnership Project Long-Term Evolution) timing schemes are defined for single carrier communication, i.e. a network component such as a base station or a user equipment receives or transmits only via one carrier. While such timings can be maintained for some configurations, some other configurations may require a new timing scheme in accordance with embodiments of the herein disclosed subject-matter in order to provide an efficient communication system which uses carrier aggregation.

Returning now to FIG. 1, the base station 102 comprises, in accordance with an embodiment, a controller 116 with a first control unit 116a and a second control unit 116b. The control unit 116b is adapted for providing timing data 120 to a user equipment, e.g. the user equipment 104. To this end, the base station further comprises a transceiver 118 which is adapted for transmitting and/or receiving transmissions such as data transmissions or control signalling transmissions. In accordance with an embodiment, the timing data 120 is the timing data determined by the timing entity 108 in accordance with embodiments of the herein disclosed subject matter. According to a further embodiment, the first control unit 116a is adapted for transmitting (and/or receiving) the control signalling transmission 112 according to the timing data 120. In other words, the first control unit 116a is adapted for adjusting the timing of the control signalling transmission 112, e.g. by respectively adjusting the transceiver 118.

In accordance with an embodiment, the user equipment 104 comprises a transceiver 122 for receiving the timing data 120. According to an embodiment, the user equipment 104 further comprises a controller 124 having a first control unit 124a and a second control unit 124b. In accordance with an embodiment, the second control unit 124b is adapted for receiving the timing data 120. In accordance with a further embodiment, the first control unit 124a is adapted for adjusting, depending on the timing data 120, a timing of the control signalling transmission 112 by specifying a timeslot in which there is available a resource of a first type on the second carrier for transmission of the control signalling transmission 112. In accordance with an embodiment, the timing of the control signalling transmission is adjusted by respectively adjusting the transceiver 122. Further as described above, the resource of the first type may be either an uplink resource or a downlink resource.

Since the timing data 120 in accordance with embodiments described with regard to FIG. 1, explicitly specifies the timing of the control signalling transmission 112, such a scheme shown in FIG. 1 is also referred to as explicit signalling scheme herein.

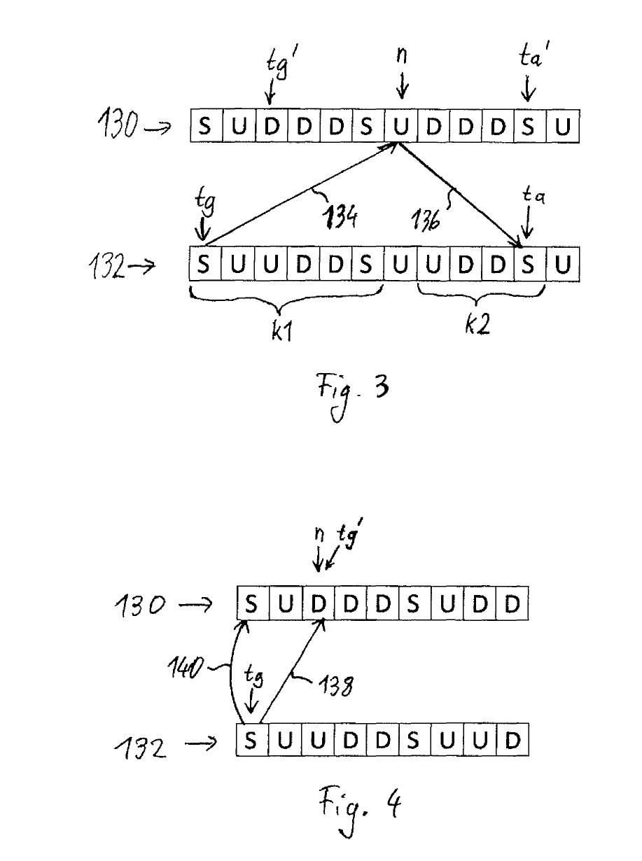

FIG. 2 shows a communication network 200 in accordance with embodiments of the herein disclosed subject matter. The communication network 200 includes a base station 202 and a user equipment 204 in accordance with embodiments of the herein disclosed subject-matter. Entities and components which are similar or identical to the entities and components described with regard to FIG. 1 are referred to with the same reference signs in FIG. 2 and the description thereof is not repeated here.

Similar to the base station 102 in FIG. 1, the base station 202 in FIG. 2 comprises a timing entity 108 in accordance with embodiments disclosed herein, the timing entity comprising a control entity 110 adapted for determining timing data defining a timing of control signalling transmission 112 being related to a data transmission 114 on first carrier. The control signalling transmission 112 is transmitted over a second carrier having a temporal configuration of its uplink and downlink resources different from the first carrier. In accordance with an embodiment, a controller 216 of the base station 202 includes a first control unit and a second control unit. However, in contrast to the operation method performed in FIG. 1, the second control unit 216b of the controller 216 of the base station 202 in FIG. 2 is adapted for providing configuration indicating data 220 to the user equipment 204, wherein the configuration indicating data 220 is indicative of the temporal configuration further on the uplink and downlink resources of the first carrier and is also indicative of the temporal configuration of the uplink and downlink resources of the second carrier. The first control unit 216a is adapted for adjusting the timing of the control signalling transmission 114 on the base station side, e.g. by respectively adjusting the transceiver 118 of the base station.

The configuration indicating data 220, in particular the temporal configuration of the uplink and downlink resources of the first and second carrier, allows the user equipment 204 by itself to determine the timing of the control signalling transmission 112. To this end, the user equipment 204 comprises a timing entity 108 in accordance with embodiments of the herein disclosed subject-matter. For example, in accordance with embodiments of the herein disclosed subject-matter, the timing entity 108 comprises a control entity 110 which is adapted for determining, based on the configuration indicating data, timing data defining a timing of the control signalling transmission 112 which is related to the data transmission 114 on the first carrier. For example, in accordance with an embodiment, the timing data specify for the control signalling transmission a timeslot in which there is available a resource of the first type on the second carrier for a transmission of the control signalling transmission on the second carrier. According to an embodiment, the user equipment 204 further comprises a controller 224 having a first control unit 224a and a second control unit 224b. The second control unit 224b is adapted for receiving the configuration indicating data 220. The first control unit 224a is adapted for receiving the timing data from the control entity 110 and adjusting, depending on these timing data a timing of a control signalling transmission 112, e.g. by specifying a timeslot in which there is available a resource of a first type on the second carrier for transmission of the control signalling transmission 112. In accordance with an embodiment, the timing of the control signalling transmission 112 on the user equipment side is adjusted by respectively adjusting the transceiver 122 of the user equipment

Hence, in accordance with embodiments of the herein disclosed subject-matter, no explicit timing data, which define a timing of a control signalling transmission, are transmitted from the base station 202 to the user equipment 204, but rather configuration indicating data 220 which are indicative of the temporal configuration of the uplink and downlink resources of the first and second carrier may be provided to the user equipment 204 by the base station 202. As mentioned above, this allows the user equipment to determine the timing of the control signalling transmission by itself, e.g. by means of a timing entity 108 disclosed herein. Further, since the timing of the control signalling transmission 112 is only implicitly provided to the user equipment 204, a scheme as shown in FIG. 2 is also referred to as implicit signalling scheme herein.

FIG. 3 illustrates a temporal configuration of two carriers and respective transmissions in accordance with embodiments of the herein disclosed subject matter. In particular, FIG. 3 shows an embodiment of two carriers 130, 132 which may be provided for example by an air interface 106 as described with regard to FIGS. 1 and 2. The two carriers which are referred to as first carrier 130 and second carrier 132 in the following, have a carrier specific time division duplex configuration (TDD configuration), i.e. a carrier-specific temporal configuration of the uplink and downlink resources of the respective carrier. In FIG. 3, an “U” describes an uplink resource or a timeslot providing an uplink resource. Similarly, “D” relates to a timeslot providing a downlink resource. Further, “S” relates to a timeslot of a special type. For example, such a timeslot of special type may include a downlink pilot timeslot, an uplink pilot timeslot and/or a guard period. For the following discussion, the special timeslot “S” is considered as providing a downlink resource.

Further, it should be noted that the term “timeslot” used herein relates to a timeslot in its general meaning, i.e. to a specific time interval used for transmissions in a communication network as described herein. For example, according to an embodiment, a timeslot may be a sub-frame as defined in 3GPP TS 36.211 v 9.1.0 (March 2010). In the following, we use this term “sub-frame” synonymously for the term “time slot”. However, it should be understood that a sub-frame is just an example of a time slot in a specific embodiment of the herein disclosed subject matter. In order to provide more general embodiments, the term “sub-frame” may be replaced by “time slot” in the following, as the statements given below are also applicable for “time slots” in general. Such general embodiments are also considered as being disclosed with this application.

In the following, with regard to FIG. 3 we refer to a data transmission on the first carrier 130 occurring in a first sub-frame n. Further for the following discussion, it is assumed that the second carrier 132 forms a scheduling cell and the first carrier 130 forms a scheduled cell. For single carrier transmissions, for example according to LTE release 8, the uplink grant timing for an uplink sub-frame on the scheduled cell where the data transmission occurs, such an uplink grant transmission would have been transmitted at the timeslot n−4, indicated at tg′. Such an uplink grant transmission requires a downlink resource as it is available in the first carrier 130. However, with a carrier aggregation where the uplink grant transmission is to be transmitted on the scheduling cell, i.e. on the second carrier 132, in the timeslot tg′ there is no downlink resource available on the second carrier 132. Hence, in accordance with an embodiment, the control entity of a timing entity as disclosed herein is adapted for determining timing data wherein the timing data specify for an uplink grant signalling transmission a second timeslot tg=n−k1, wherein k1 is the smallest number of timeslots which spaces the second timeslot tg from the first timeslot n by a time duration greater than or equal to a maximum time duration required for signalling between the base station and the user equipment and which ensures that the second timeslot provides a downlink resource on the second carrier 132. It should be mentioned that in LTE release 9 k1 is equal to four sub-frames. Further, for the discussion of the exemplary embodiments disclosed herein we further assume that maximum time duration required for signalling between the base station and the user equipment is also four subframes.

Having now regard to the exemplary carrier configuration of the second carrier 132, one recognizes that the second timeslot tg corresponds to k1=6, i.e. according to an embodiment the uplink grant signalling transmission is performed in the special timeslot S at tg in FIG. 3.

Having now regard to the acknowledgement of the data transmission occurring at the first timeslot n, single carrier LTE release 8 timing provides the acknowledgement in a timeslot n+4, indicated at ta′ in FIG. 3. Now, having regard to the carrier aggregation and the second carrier 132 in FIG. 3, in this exemplary embodiment there is also available a downlink resource at the timeslot n+4, indicated at ta in FIG. 3.

In order to more clearly show the relationship of the uplink grant at tg and the uplink acknowledgement ta for the data transmission occurring at timeslot n, this relationship is indicated with two arrows 134, 136. However, it should be emphasized that these arrows 134, 136 do not relate to a transmission occurring between the second carrier 132 and the first carrier 130, but rather indicate the relationship of the control signalling transmissions occurring at tg and ta on the second carrier 132 and the related data transmission occurring at timeslot n on the first carrier 130.

Although in FIG. 3 the LTE release 8 timing is also applicable to the carrier aggregation case for the specific carrier configuration shown in FIG. 3, generally the timing data provided by the control entity of the timing entity further specify for an acknowledgement/non-acknowledgement signalling transmission a third timeslot ta=n+k2, wherein k2 is the smallest number of timeslots which spaces the third timeslot ta from the first timeslot n by a time duration greater than or equal to a maximum time duration required for signalling between the base station the user equipment and which ensures the third timeslot providing a downlink resource on the first carrier 130.

Further, having again regard to the exemplary embodiment of LTE, the second carrier 132 provides at the second timeslot tg a physical downlink control channel (PDCCH) for an uplink grant. Further, at the first timeslot n the first carrier 130 provides a physical uplink shared channel (PUSCH). Further, the second carrier 132 provides at the third timeslot ta a physical indicator channel (PHICH).

FIG. 4 illustrates a timing of a control signalling transmission in accordance with embodiments of the herein disclosed subject-matter.

FIG. 4 relates to a downlink data transmission on the first carrier 130 occurring in a first timeslot n. According to an embodiment, the timing data specify for a downlink assignment signalling transmission a second timeslot tg which is the latest timeslot before n providing a downlink resource on the second carrier 132.

Again the relationship between the downlink assignment signalling transmission occurring at tg on the second carrier 132 and the corresponding data transmission occurring on the first carrier 130 at the first timeslot n is indicated with an arrow 138.

The timing introduced with an embodiment exemplary embodiment illustrated in FIG. 4 allows scheduling of a downlink sub-frame in the first timeslot n even if there is no downlink resource available at the first timeslot n on the second carrier 132. In other words, having regard to LTE, in the exemplary embodiment shown in FIG. 4 at the first timeslot n there is no physical downlink control channel available on the second carrier 132 for a downlink assignment.

It should be noted that if a downlink resource is available on both the first carrier 130 and the second carrier 132, a downlink transmission can be scheduled in the same timeslot as this requires no further communication with the user equipment. This situation shown in FIG. 4, where a downlink resource is available for downlink assignment in the second carrier 132 as well as a downlink resource is available for data transmission in the first carrier 130. The relationship between the respective data transmission on the first carrier 130 and the downlink assignment on the second carrier 132, both occurring in the second time slot tg, is indicated by the arrow 140 in FIG. 4.

For single carrier transmissions, for example according to LTE release 8, the downlink assignment for the data transmission occurring at the first time slot n would have been transmitted at the same timeslot, indicated at tg′ FIG. 4.

According to an embodiment, one downlink data transmission occurring at the second timeslot tg may schedule multiple downlink data transmissions on other cells. According to a further embodiment, an indicator is included in a downlink control information (DCI) to indicate to which downlink timeslot the assignment is referring. According to an embodiment, these indicators can be jointly coded with the carrier indicator format (CIF).

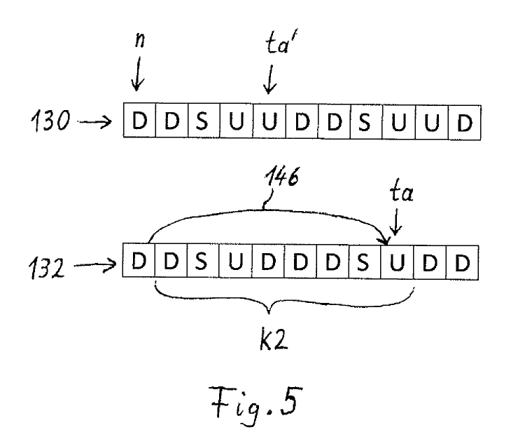

FIG. 5 illustrates a timing of a control signalling transmission in accordance with embodiments of the herein disclosed subject-matter.

FIG. 5 exemplarily shows a downlink data transmission on the first carrier 130 occurring in a first timeslot n. In accordance with an embodiment, the timing data specify for an acknowledgement/non-acknowledgement signalling transmission a second timeslot ta=n+k2 wherein k2 is the smallest number of timeslots which spaces the second timeslot ta from the first timeslot n by a time duration greater than or equal to a maximum time duration (e.g. four sub-frames as in the illustrated case) required for signalling between the base station and the user equipment and which ensures the second timeslot ta providing an uplink resource on the second carrier. As shown in FIG. 5, in the exemplary embodiment k2=8, i.e. ta=n+8.

It should be mentioned, that according to single carrier transmissions in LTE the timeslot for the acknowledgement/non-acknowledgement signalling transmission would have been n+4, indicated at ta′ in FIG. 5. Further, the relationship between the downlink data transmission occurring in the first time slot n and the acknowledgement/non-acknowledgement signalling transmission occurring in the second timeslot ta is indicated with an arrow 146 in FIG. 5.

Having regard to the subject matter disclosed herein, it should be mentioned that generally the term sub-frame is only used as an exemplary example for a time slot.

Further, although some embodiments refer to a “base station” or an “e-NodeB” in case of LTE, it should be understood that each of these references is considered to implicitly disclose a respective reference to the general term “network access node”. Also other terms which relate to specific standards or specific communication techniques are considered to implicitly disclose the respective general term with the desired functionality.

It should further be noted that a base station, a user equipment or a timing entity as disclosed herein are not limited to dedicated entities as described in some embodiments. Rather, the herein disclosed subject matter may be implemented in various ways in various locations in the communication network while still providing the desired functionality.

It should further be noted that any entity disclosed herein (e.g. components, units and devices, such as controllers or entities) are not limited to a dedicated entity as described in some embodiments. Rather, the herein disclosed subject matter may be implemented in various ways and with various granularity on device level or software module level while still providing the desired functionality. For example, the control units (e.g. 116a, 116b) of a controller, and, optionally, also the control entity of the timing unit may be implemented by a single controller, just to name one example of alternative configurations. Further, it should be noted that according to embodiments a separate entity (e.g. a software module, a hardware module or a hybrid module) may be provided for each of the functions disclosed herein. According to other embodiments, an entity (e.g. a software module, a hardware module or a hybrid module (combined software/hardware module)) is configured for providing two or more functions as disclosed herein. According to an embodiment, a controller such as the control entity 110 or the controllers 116, 124, 216, 224 comprises a processor device including at least one processor for carrying out at least one computer program corresponding to a respective software module. Generally, the functionality of two or more controllers or control entities described herein may be provided by a single controller. For example, two or more controllers or control entities may be provided by respective computer programs executed by a single processor device.

It should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.

In order to recapitulate the above described embodiments of the present invention one can state:

There is provided a timing entity for a communication network which includes a base station and a user equipment capable of communicating with each other over at least two carriers which have different temporal configuration of its uplink and downlink resources. The timing entity comprises a control entity adapted for determining timing data defining a timing of a control signalling transmission which is related to a data transmission on a first carrier and which uses a resource of a first type on the second carrier. According to an embodiment the timing data specify for the control signalling transmission a time slot in which there is available a resource of the first type on the second carrier for the control signalling transmission. The control entity may be implemented in a base station and/or a user equipment. Respective methods and computer programs are also disclosed.

Further, having regard to the explicit signalling scheme and the implicit signalling scheme, on can specify the following exemplary embodiments:

For explicit signaling a base station (e.g. eNB) contains

1) a transceiver for transmitting and receiving data and control signaling transmission
2) a first control unit for adjusting the transceiver based on the timing data
3) a second control unit for providing the timing data to the user equipment
4) a timing entity

For explicit signaling a user equipment contains

1) a transceiver for transmitting and receiving data transmission and control signaling transmission
2) a first control unit for adjusting the transceiver based on the timing data
3) a second control unit for receiving the timing data to user equipment

For implicit signaling eNB contains

1) a transceiver for transmitting and receiving data transmission and control signaling transmission
2) a first control entity for adjusting the transceiver based on the timing data
3) a timing entity

For implicit signaling the user equipment contains

1) a transceiver for transmitting and receiving data transmission and control signaling transmission
2) a first controller for adjusting the transceiver based on the timing data
3) a timing entity

### LIST OF REFERENCE SIGNS

100 communication network
102 base station
104 user equipment
106 air interface
108 timing entity
110 control entity
112 control signalling transmission
114 data transmission
116 controller of 102
116a first control unit of 116
116b second control unit of 116
118 transceiver
120 timing data
122 transceiver
124 controller of 104
124a first control unit of 124
124b second control unit of 124
130 first carrier
132 second carrier
134, 136, 138, 140, 146 arrow indicating a relationship between transmissions
200 communication network
202 base station
204 user equipment
216 controller of 202
216a first control, unit of 216
216b second control unit of 216
220 configuration indicating data
224 controller of 204
224a first control unit of 224
224b second control unit of 224

1. Timing entity of a communication network including a base station and a user equipment capable of communicating with each other over at least two carriers, the at least two carriers including a first carrier and a second carrier, both having uplink and downlink resources, the first carrier and the second carrier having different temporal configuration of its uplink and downlink resources, the timing entity comprising:
a control entity adapted for determining timing data defining a timing of a control signalling transmission being related to a data transmission on the first carrier;
the control signalling transmission using a resource of a first type on the second carrier, wherein the resource of the first type is either an uplink resource or a downlink resource; and
the timing data specifying for the control signalling transmission a time slot in which there is available a resource of the first type on the second carrier for the control signalling transmission.

2. Timing entity according to claim 1,
the data transmission occurring in a first time slot; and
the timing data specifying for the control signalling transmission a second time slot;
the second time slot being spaced by a temporal distance from the first time slot;
the temporal distance being greater than or equal to a maximum time duration required for signalling between the base station and the user equipment while the second time slot is the temporally closest time slot providing a resource of the first type required for the control signalling transmission.

3. Timing entity according to claim 1, wherein
the data transmission is an uplink data transmission on the first carrier occurring in a first, time slot; and
the control signalling transmission is an uplink grant signalling transmission;
the timing data specifying for the uplink grant signalling transmission a second time slot tg=n−k1, wherein k1 is the smallest number of time slots which
spaces the second time slot from the first time slot by a time duration greater than or equal to a maximum time duration required for signalling between the base station and the user equipment; and
ensures the second time slot providing a downlink resource on the second carrier.

4. Timing entity according to claim 1 wherein
the data transmission is an uplink data transmission on the first carrier occurring in a first time slot n; and
the control signalling transmission is an acknowledgement/non-acknowledgement signalling transmission;
the timing data specifying for the acknowledgement/non-acknowledgement signalling transmission a second time slot ta=n+k2, wherein k2 is the smallest number of time slots which
spaces the second time slot from the first time slot by a time duration greater than or equal to a maximum time duration required for signalling between the base station and the user equipment; and
ensures the second time slot providing a downlink resource on the second carrier.

5. Timing entity according to claim 1, wherein
the data transmission is an downlink data transmission on the first carrier occurring in a first time slot; and
the control signalling transmission is a downlink assignment signalling transmission;
the timing data specifying for the downlink assignment signalling transmission a second time slot which is the latest time slot before the first time slot that provides a downlink resource on the second carrier.

6. Timing entity according to claim 1 wherein
the data transmission is a downlink data transmission on the first carrier occurring in a first time slot; and
the control signalling transmission is an acknowledgement/non-acknowledgement signalling transmission;
the timing data specifying for the acknowledgement/non-acknowledgement signalling transmission a second time slot to =n+k2, wherein k2 is the smallest number of time slots which
spaces the second time slot from the first time slot by a time duration greater than or equal to a maximum time duration required for signalling between the base station and the user equipment and o ensures the second time slot providing an uplink resource on the second carrier.

7. Base station of a communication network, the base station comprising:
a timing entity according to claim 1; and
a controller for transmitting and receiving the control signalling transmission according to the timing data.

8. Base station according to claim 7,
wherein optionally the controller
either is configured for providing the timing data to the user equipment or
is configured for providing the configuration indicating data to the user equipment.

9. User equipment for a communication network, the user equipment comprising:
a timing entity according to claim 1;
the user equipment comprising a controller for transmitting and receiving the control signalling transmission according to the timing data;
wherein the controller is further configured for receiving the configuration indicating data from the base station.

10. User equipment of a communication network, the communication network further including a base station, the user equipment and the base station being capable of communicating with each other over at least two carriers, the at least two carriers including a first carrier and a second carrier, both having uplink and downlink resources, the first carrier and the second carrier having different temporal configuration of its uplink and downlink resources, the user equipment comprising:
a controller being adapted for receiving timing data from the base station, the timing data defining a timing of a control signalling transmission being related to a data transmission on the first carrier; the controller being adapted for adjusting, depending on the timing data, the timing of the control signaling transmission by specifying a time slot in which there is available a resource of a first type on the second carrier for the control signaling transmission; and
the resource of the first type being either an uplink resource or a downlink resource.

11. Method of operating a timing entity of a communication network including a base station and a user equipment capable of communicating with each other over at least two carriers the at least two carriers including a first carrier and a second carrier, both having uplink and downlink resources, the first carrier and the second carrier having different temporal configuration of its uplink and downlink resources, the method comprising:
determining timing data defining a timing of a control signalling transmission being related to a data transmission on the first carrier;
the control signalling transmission being related to the data transmission on the first carrier using a resource of a first type on the second carrier, wherein the resource of the first type is either an uplink resource or a downlink resource; and
the timing data specifying for the control signalling transmission a time slot in which there is available a resource of the first type on the second carrier for a transmission of the control signalling being related to the data transmission on the first carrier.

12. Method of operating a base station, the method comprising:
determining timing data according to the method of claim 11.

13. Method of operating a user equipment of a communication network, the method comprising:
determining timing data according to the method of claim 11.

14. Method of operating a controller of a user equipment of a communication network, the communication network further including a base station, the user equipment and the base station being capable of communicating with each other over at least two carriers, the at least two carriers including a first carrier and a second carrier, both having uplink and downlink resources, the first carrier and the second carrier having different temporal configuration of its uplink and downlink resources, the method comprising:
receiving timing data from the base station, the timing data defining a timing of a control signalling transmission being related to a data transmission on the first carrier;
adjusting, depending on the timing data, the timing of the control signaling transmission by specifying a time slot in which there is available a resource of a first type on the second carrier for the control signaling transmission; and
the resource of the first type being either an uplink resource or a downlink resource.

15. A computer program, the computer program being adapted for, when being executed by a data processor, controlling the method as set forth in claim 11.
